(19) United States
(12) Patent Application Publication
(10) Pub. No.: US 2009/0223412 A1
(43) Pub. Date: Sep. 10, 2009

(54) Stable suspension of crystalline tiO2 particles of hydrothermally treated sol-gel precursor powders

(76) Inventors: Matthias Bockmeyer, Mainz (DE); Bettina Herbig, Thüngersheim (DE); Peer Löbmann, Gerbrunn (DE)

Correspondence Address: EDWARDS ANGELL PALMER & DODGE LLP, P.O. BOX 55874, BOSTON, MA, 02205, US

(21) Appl. No.: 12/309,286

(22) PCT Filed: Jul. 11, 2007
(86) PCT No.: PCT/EP2007/006159

§ 371 Date: Mar. 23, 2009

(30) Foreign Application Priority Data
Jul. 14, 2006 (DE) 10 2006 032 755.1

(51) Int. Cl. C09D 1/00

(52) U.S. Cl. 106/287.19

(57) ABSTRACT

The invention relates to a method for producing stable suspensions of finely dispersed colloidal crystalline titanium dioxide particles, comprising the hydro-thermal treatment of aqueous molecularly disperse sol-gel solutions prepared from amorphous water-soluble precursor powders. The suspensions thus obtained can be used, inter alia, for the production of thin transparent crystalline layers.

The invention relates to the preparation of stable suspensions of crystalline titanium dioxide particles which are contained in the suspension in finely dispersed or colloidal form. The suspensions can be used both for the preparation of porous layers as well as starting material for the incorporation of finely dispersed titanium dioxide nanoparticles into materials.

Crystalline colloidal systems are known in the state of the art and described, for example, by Lei Ge et al. in “Key Engineering Material”, 2005, Vol. 280-283, p. 809-812. Commercially available products are, for example, “P25” of Degussa AG and “XXS 100” of Sachtleben Chemie GmbH.

They can also be used for the preparation of anatase layers; however, due to the acidic stabilization and/or their method of production, they are only partly miscible with amorphous sol-gel precursors in order to obtain stable coating solutions.

The hydrothermal treatment of sol-gel solutions in water (e.g., TiCl₄, TiOR₄) is known; however, as far as is known, this does not result in stable colloidally dispersed solutions. Precursors with chelating ligands are not used. Therefore, a method of production of stable crystalline colloidally dispersed TiO₂ solutions by hydrothermal treatment of sol-gel precursor powders stabilized with complexing agents such as acetyl acetone is not known.

Numerous amorphous sol-gel precursors for the preparation of anatase layers are known. Of the same transparency, these layers exhibit only a relatively low degree of porosity (5-20%). However, with these layers, due to a kind of surrounding sintering skin on the layer, open and close porosity must often be distinguished. Although the porosity of these layers can be markedly increased by using macromolecular additives such as polyethylene glycol (PEG) or polyvinyl pyrrolidone (PVP) this kind of porosity is due only to fissures on the μm scale in the layers and not due to a defined pore structure on the nanometer scale. Moreover, these fissures result in marked reduction of the optical quality of the layers, which become opaque or cloudy.

The object of the invention is to provide a suspension for the coating of substrates by which the aforementioned problems can be avoided. In particular, the suspension is to make it possible to prepare thin transparent crystalline layers having a large surface area, porosity and scratch resistance in particular on substrates such as glass, ceramics and metals.

A further object of the invention is to provide substrates having photocatalytically active layers.

A further object is to prepare dispersions of crystalline TiO₂ particles which may be mixed with amorphous sol-gel coating materials without precipitation.

A further object of the invention is to provide substrates having hydrophilic layers which are easy to clean and which do not fog up, i.e., which have so-called easy to clean and antifogging properties.

A further object of the invention is to provide substrates having layers with particle-repellent (for example dust-repellent, soot-repellent) properties.

A further object of the invention is to provide a method for the coating of thermally sensitive materials. Furthermore, there are to be provided coatings with antimicrobial properties as may be used, e.g., in air conditioning systems in the automotive industry.

Finally, the suspension is also to serve as coating for plastics and as a starting material for incorporation of finely dispersed titanium dioxide particles into other materials.

These objections are achieved according to a first aspect of the invention by a method for preparing stable suspensions of colloidally dispersed crystalline titanium dioxide particles comprising the hydrothermal treatment of aqueous molecularly dispersed sol-gel solutions prepared from amorphous water-soluble precursor powders.

The suspensions prepared according to the method of the invention are long-term stable, i.e., they can be used over periods of at least half a year.

The preparation of the colloidally dispersed suspension according to the invention is carried out by hydrothermal treatment of aqueous molecularly dispersed sol-gel solutions, wherein this refers to the crystallization of titanium dioxide particles from aqueous solutions heated to high temperatures (hydrothermal synthesis), i.e., the solution used in the method according to the invention has a temperature above the boiling point of water at normal pressure. Therefore, the hydrothermal treatment requires to use autoclaves.

According to this method, a precursor powder is first dissolved in water or in an aqueous solvent in an amount of ≦20 wt.-%, relative to TiO₂.

Suitable aqueous solvents are mixtures of water and an organic solvent selected from the group consisting of alcohols, diols, diol ethers and amines.

In the method according to the invention, the hydrothermal treatment is normally carried out at a temperature in the range of 120-250° C. The temperature range of 160-180° C. is particularly preferred.

The duration of the treatment is generally 1-48 h, preferably 12-16 h.

In the aforementioned temperature range, the pressure amounts to about 5 bar.

The product obtained after the hydrothermal treatment is suitably taken up on a medium selected from ethanol and filtered. For this purpose, a pressure filtration apparatus having a pore size of about 1 μm may be used.

The amorphous water-soluble precursor powder used in the method according to the invention may be, in particular, a precursor powder as described in European patent application EP 1 045 815 A1. This is prepared by
(a) reacting a titanium alcoholate of the general formula Ti(OR)₄, wherein the residues R may be the same or different and are linear, branched or cyclic alkyl or alkenyl residues having 1 to 10 carbon atoms, optionally having one or more carbonyl and/or ester and/or carboxy functions, with one or more polar compound(s) with complexing, chelating properties,
(b) heating the solution,
(c) adding water to the solution, optionally in the presence of a catalyst (e.g. carboxylic acids, p-toluene sulfonic acid),
(d) concentrating the solution until a powder is obtained.

According to a preferred embodiment, the titanium alcoholate is provided first and the polar compound is added thereto (preferably by dripping).

According to a preferred embodiment of the method, there are used titanium alcoholates of the general formula Ti(OR)₄, wherein R represents a linear or branched alkyl residue having 2 to 6 carbon atoms. Furthermore, it is preferred that one or more of the OR residues of the aforementioned formula is derived from oxo esters, β-diketones, carboxylic acids, keto carboxylic acids or keto alcohols. It is particularly preferred that the OR residue is derived from acetyl acetone. Examples for suitable titanium alcoholates are Ti(OEt)₄, Ti(Oi-Pr)₄, Ti(On-Pr)₄ and Ti(AcAc)₂(Oi-Pr)₂.

The polar complexing and chelating compounds are preferably diketones, β-keto esters, glycol ethers, diols, polyvalent alcohols, amino alcohols, glycerol, hydroxy diols, amino thiols, ditihols, diamines or mixtures thereof.

The use of diketones, in particular of 1,3-diketones such as acetyl acetone, is particularly preferred.

The polar complexing and chelating compound is used in an amount of 0.5 to 20 mol/mol, preferably 0.5 to 3 mol/mol, relative to the titanium alcoholate.

After reaction of the titanium alcoholate with the polar complexing and chelating compound, the resulting solution is heated to a temperature in the range of room temperature to the boiling point of the solvent, preferably 80 to 100° C. over a period of up to 24 hours, preferably over a period of 0.5 to 2 hours.

Subsequently, an amount of 0.5 to 20, preferably 1 to 5 mol of H₂O per mole titanium alcoholate is added to the solution, optionally in the presence of a catalyst (H₃O⁺, OH⁻) or dilute inorganic or organic acids or bases, such as HNO₃, HCl, p-toluene sulfonic acid, carboxylic acids, NaOH or NH₃, or dilute solutions of metal salts such as NaBF₄, and the mixture is concentrated, preferably under reduced pressure. This yields a powdery solid having a titanium dioxide content of 30 to 60 wt.-%.

In a closed vessel, the powder can be stored for unlimited periods of time.

As mentioned above, this powder can then be dissolved in water or aqueous solvents for the preparation of an aqueous, molecularly dispersed sol-gel solution. As described above, this is then subjected to a hydrothermal treatment.

The particle size or agglomerate size of the thus obtained colloidally dispersed solutions according to the invention can be controlled by the pH used in the hydrolysis for the preparation of the amorphous, water-soluble precursor powder. Under identical conditions, low pHs result in lower particle or agglomerate sizes.

Furthermore, the particle or agglomerate size depends on the selection and concentration of the reagent for acidic hydrolysis in the precursor powder synthesis.

Finally, the ratio of titanium alcoholate to complexing agent and water also has an influence on the particle size or agglomerate size of the colloidally dispersed solutions according to the invention.

Furthermore, cationic surfactants such as CTAB and neutral surfactants (block copolymers) may be added to the sol-gel solutions prepared from the amorphous water-soluble precursor powders. Such surfactants can be added in an amount of ≦10 wt.-% and do not adversely affect the stability of the aqueous precursor powder solutions. The addition of surfactants results in the formation of micelles, whereby the structuring of the titanium dioxide particles during the hydrothermal treatment is possible.

The amorphous water-soluble precursor powders used can contain dopants in an amount of ≦10 mol-%, relative to TiO₂. The dopant can be added either after reaction of the titanium alcoholate with the polar complexing and chelating compound or to the medium for the hydrothermal treatment. Suitable dopants are, for example, Fe, Mo, Ru, Os, Re, V, Rh, Nd, Pd, Pt, Sn, W, Sb, Ag and Co. These may be added in an stoichiometrically appropriate amount to the starting materials or the medium in the form of their salts.

After the hydrothermal treatment, there are obtained the suspensions of titanium dioxide particles according to the invention which still contain about 10-15% of functional organic groups resulting from the titanium alcoholates used in the synthesis of the precursor powders. These organic components decompose only at a pyrolysis temperature of about 300° C.

The suspensions prepared according to the aforementioned method, which are also provided by the present invention, may be used both for the production of porous layers and as starting material for the incorporation of finely dispersed titanium nanoparticles into materials. Porous layers are produced, for example, by immersing the substrate to be coated into the suspension according to the invention (and subsequent drying of the dip coated substrate), wherein fissure-free layers having layer thicknesses of 100-500 nm are obtained across the entire temperature range of 100-1700° C. The porosity of these layers, determined (according to Lorentz) about 35 to 40%, remains constant up to 600° C. Up to 600° C., the titanium dioxide is present as anatase, i.e., no phase transition occurs. The crystallite size (according to Debye-Scherrer) increases from 11 nm at room temperature to 16 nm at 600° C.

By the addition of amorphous molecularly dispersed particles to the solution containing colloidally dispersed titanium particles according to the invention, layers having defined porosities and defined pore radii may be obtained.

Such amorphous molecularly dispersed particles consist, for example, of TiO₂, ZrO₂, SiO₂, perowskites, pyrochlore compounds and further oxidic compounds, the preparation of which is described in “Nanoparticles: From Theory to Application”, Edited by Günter Schmid, 2004, Wiley-VCH Verlag GmbH & Co. KG, Weinheim”. They are added to the suspension according to the invention in amounts of 1-99% such that porosities in the range of 5-50% residual porosity and pore radii in the range of 20 nm to 1 nm may be obtained.

A further advantage of the method according to the invention and the suspension according to the invention lies in the fact that the starting materials are commercially available and non-toxic. The reactions are carried out in a single vessel and the sol-gel precursor powder described in EP 1 045 815 A1 (which may be used in the method according to the invention) may be stored under air for unlimited periods of time.

The colloidally dispersed suspensions or solutions or mixtures of molecularly dispersed and colloidally dispersed particles according to the invention prepared therefrom are equally long-term stable.

They may be used for the preparation of defect-free layers of high optical homogeneity and uniform quality by dip coating. The solutions have the advantage that the microstructure, in particular pore volumes, pore radii and inner surfaces, of thin TiO₂ layers can be adjusted in a controlled way. Unlike in the state of the art, this provides the possibility to selectively adjust the layer properties for numerous applications.

Due to the miscibility with molecularly dispersed amorphous sol-gel precursors, it is also possible not only to adjust the micro structural properties, but to specifically markedly increase the scratch resistance of porous TiO₂ layers with only small losses in porosity.

Due to the fact that crystalline particles are already present, crystalline layers with comparatively low sintering temperatures compared to classical sol-gel coatings can be prepared.

In summary, the presence of finely dispersed titanium dioxide particles in the suspensions according to the invention allows for the following technical applications:
(i) The preparation of thin transparent crystalline layers having a large surface area, porosity and scratch resistance on glass, ceramics and metals.
(ii) The preparation of photocatalytically active layers.
(iii) The preparation of hydrophilic layers having easy to clean and antifogging properties.
(iv) Coatings with antimicrobial properties, for example in air conditioning systems in the automobile industry.
(v) The coating of plastics.
(vi) The coating of other thermally sensitive materials.
(vii) Starting materials for finely dispersed nanoparticles for incorporation into other materials, for example plastics, in order to increase the refractive index.
(viii) Coatings with self-cleaning properties
(ix) Coatings with particle-repellent (for example dust-repellent, soot-repellent) properties

The invention is further illustrated by the following example.

### EXAMPLE

### Precursor Powder Synthesis

1.5 mol of titanium tetraethylate are provided in a 2 l round bottom flask and one mol of acetyl acetone is subsequently added via a dropping funnel with stirring. The solution is stirred for one hour and is hydrolyzed with 5 mols of water in which 0.1 mol of p-toluene sulfonic acid is dissolved. All volatile components are then removed by rotary evaporation at 80° C. bath temperature. Typical oxide contents are ˜57 wt.-%.

### Hydrothermal Treatment

Starting from the water-soluble titanium dioxide precursor powder described above, a 12 wt.-% TiO₂-sol is prepared in a 500 ml phiol with screw-on-lid. For this purpose, 109.1 g of the precursor powder (55 wt.-%) per 390.9 g of water are weighed in and then stirred for 24 h. After obtaining a clear red solution, 500 g of this solution are transferred to a 500 ml Teflon vessel and then sealed in an autoclave and treated hydrothermally at 160° C. for 16 h. The resulting gel is subsequently taken up in 400 g of ethanol and filtered by means of a pressure filtration apparatus (1 μm).

The 6 wt.-% solution according to the invention thus obtained can now be used for the preparation of 200 nm thick porous layers by dip coating (pulling rate: 10 cm/min). If the wet films are stored for ten minutes at 600° C., it is possible to obtain photocatalytically active titanium dioxide layers having a porosity of about 40% and a surface area of about 70 m²/g.

1. A method for producing stable suspensions of finely dispersed colloidal crystalline titanium dioxide particles, comprising the hydrothermal treatment of aqueous molecularly dispersed sol-gel solutions prepared from amorphous water-soluble precursor powders.

2. The method of claim 1, wherein the molecularly dispersed sol-gel solution is prepared by dissolving the precursor powders in water or an aqueous solvent in an amount of ≦20 wt.-% relative to TiO₂.

3. The method of claim 1, wherein the amorphous water-soluble precursor powders used contain dopants in an amount of ≦10 mol-% relative to TiO₂.

4. The method of claim 2, wherein a mixture of water and an organic solvent selected from the group consisting of alcohols, diols, diol ethers and amines is used as aqueous solvent.

5. The method of claim 4, wherein a mixture of propane diol, triethanol amine and water is used as solvent.

6. The method of claim 1, wherein the hydrothermal treatment is carried out at a temperature in the range of 120-250° C.

7. The method of claim 1, wherein the hydrothermal treatment is carried out for a period in the range of 1-48 hours.

8. The method of claim 1, wherein the hydrothermal treatment is carried out at a pressure in the range of 2 to 10 bar.

9. The method of claim 1, wherein the product obtained after the hydrothermal treatment is taken up in a medium selected from ethanol and filtered.

10. The method of claim 1, wherein dopants are added to the medium for the hydrothermal treatment in an amount of ≦10 mol-% relative to TiO₂.

11. The method of claim 1, wherein the amorphous water-soluble precursor powder is a powder which is obtainable by
(a) reacting a titanium alcoholate of the general formula Ti(OR)₄, wherein the residues R may be the same or different and are linear, branched or cyclic alkyl or alkenyl residues having 1 to 10 carbon atoms, optionally having one or more carbonyl and/or ester and/or carboxy functions, with one or more polar compound with complexing, chelating properties,
(b) heating the solution,
(c) adding water to the solution, optionally in the presence of a catalyst (e.g. carboxylic acids, p-toluene sulfonic acid),
(d) concentrating the solution until a powder is obtained.

12. The method of claim 11, wherein the titanium alcoholate is provided first and the polar compound is added thereto.

13. The method of claim 11, wherein the polar compound having complexing, chelating properties is a diketone, β-keto ester, acetyl acetone, glycol ether, diol, polyvalent alcohol, amino alcohol, glycerol, hydroxy diol, amino thiol, dithiol, diamine, carboxylic acid or a mixture thereof.

14. The method of claim 13, wherein the polar compound having complexing, chelating properties is acetyl acetone.

15. A stable suspension of crystalline titanium dioxide particles, obtainable by the method according to claim 1.

16. The suspension of claim 15, wherein the suspension contains the particles in an amount of 1 to 15 wt.-%.

17. The suspension of claim 15, wherein the suspending agent is selected from the group consisting of alcohols, carboxylic acids and further polar and apolar solvents.

18. The suspension of claim 15, wherein the primary particle size of the titanium dioxide particles lies in the range of 4 to 20 nm.

19. The suspension of claim 15, wherein the size of the agglomerates of the titanium dioxide particles lies in the range of 5 to 150 nm.

20. The suspension of claim 15, wherein the titanium dioxide particles have functional organic groups in an amount of 5 to 15 wt.-%.

21. The suspension of claim 15, wherein the suspension further contains amorphous molecularly dispersed particles.

22. Use of the suspension according to claim 15 for the preparation of thin transparent crystalline layers on a substrate.

23. The use of claim 22, wherein the substrate is selected from the group consisting of glass, ceramic, metal and plastic substrates.

24. The use of claim 22, wherein the substrate is thermally sensitive.

25. The use of claim 22, wherein the layer is photocatalytically active or has antimicrobial properties or is a hydrophilic layer having easy to clean and antifogging properties.

26. The use of the suspension according to claim 15 for the preparation of porous titanium dioxide layers as self cleaning layers.

27. The use of the suspension according to claim 15 for the preparation of porous titanium dioxide layers as dirt-repellent layers.

28. The use of the suspension according to claim 15 as starting material for the incorporation of titanium dioxide particles into materials.
